(19) United States
(12) Patent Application Publication
(10) Pub. No.: US 2005/0021453 A1
(43) Pub. Date: Jan. 27, 2005

(54) Real estate finance instrument

(76) Inventor: Gerald G. Lyman, San Juan Capistrano, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/799,944

(22) Filed: Mar. 11, 2004

Related U.S. Application Data
(60) Provisional application No. 60/453,665, filed on Mar. 12, 2003.

(51) Int. Cl. G06F 17/60

(52) U.S. Cl. 705/38

(57) ABSTRACT

A system and method of structuring and financing a real estate transaction, such as a residential real estate transaction. A seller can maximize a selling price while minimizing the loan payments of the buyer over a predetermined period of time. A seller can purchase a financial instrument as seller paid points that can result in a reduction in the effective interest rate for the buyer. The interest rate reduction can be effective over a predetermined period of time, usually less than or equal to five years. The buyer can present the financial instrument to a lender when applying for a mortgage. The lender can redeem the financial instrument for the amount of seller paid points and supplement any mortgage. The lender can then reduce the buyer's loan payments over the predetermined period of time, based on the amount of seller paid points.

### CROSS-REFERENCES TO RELATED APPLICATIONS

This application claims the benefit under 35 U.S.C. §119(e) of U.S. Provisional Application Ser. No. 60/453,665, filed Mar. 12, 2003, the entirety of which is herein incorporated by reference.

### BACKGROUND OF THE DISCLOSURE

Residential real estate transactions typically involve a homeowner or a seller that contracts with a real estate agent to market a home to prospective buyers. The seller and the buyer have competing interests with respect to the selling price. The seller typically desires to maximize the selling price of the house. In contrast, the buyer typically seeks to minimize the amount paid for any particular house. The buyer typically seeks to leverage the amount of available cash in order to purchase the most desirable home. A buyer may offer less than the seller's asking price in an effort to obtain a more desirable home with the same amount of available cash.

One or more real estate agents can earn a commission on the sale of the home that is determined based on the selling price. Thus, a real estate agent typically benefits from a higher selling price.

In a seller dominated market, where there may be a shortage of desirable homes, or where there is a surplus of buyers, the price of homes may continually rise. A seller may have numerous buyers that are willing to pay the asking price. Buyers may attempt to make their offers somehow distinguishable and more appealing to the seller. Additionally, there may be some buyers that are willing to offer more than a seller's asking price in an effort to distinguish their offer from a competing buyer's offer.

In contrast, in a buyer dominated market, there may be a glut of homes on the market or there may be an insufficient number of buyers that have sufficient funds and income to qualify to purchase a particular home. The seller may not receive many offers, and an offer from a buyer may be below a seller's asking price. A seller can attempt to make the home more appealing to buyers in order to differentiate the home from competing properties in order to sustain the price of the home.

Typically, the most important factor for the seller is the selling price. The selling price can determine the amount of cash a seller takes out of the transaction. Typically, the most important factor for the buyer is the monthly payment, or the cash required each month. The buyer usually has a relatively fixed budget with a certain amount available for a down payment and all closing costs. The buyer also typically has a budget for each month that can be allocated to debt service on the mortgage. For the buyer, the budget may be particularly critical for the years immediately following the purchase.

Often, the buyer is limited by the amount of available cash on hand, and by the amount of the mortgage that a lending institution will extend to a buyer. Lending institutions may limit an amount it is willing to lend to a buyer based in part on the buyer's monthly income.

Various real estate financing methods are available to help a buyer qualify for a larger loan. For example, a buyer may seek an Adjustable Rate Mortgage (ARM) that begins at a low interest rate and lower monthly payments. The interest rate on the loan may vary according to a predetermined schedule and index. This option may not be completely satisfactory for a buyer because future payments may be unpredictable, and the monthly payments required to service the loan may rise quickly. Another option for the buyer is to pay to reduce the interest rate of a mortgage. A buyer may lower the interest rate of a loan by paying an amount up-front. The amount is usually calculated as a percentage of the overall mortgage, referred to as points. This approach can result in lower payments for the duration of the loan. However, it requires an initial payment be made to the lender. Such a payment is often not possible for an already cash strapped buyer.

### BRIEF SUMMARY OF THE DISCLOSURE

A system and method of structuring and financing a real estate transaction is disclosed. The real estate transaction can be, for example, a residential real estate transaction or home sale. A seller can maximize a selling price while minimizing the loan payments of the buyer over a predetermined period of time. A seller and a buyer can together create a financial instrument with seller paid points that can result in lower monthly payments for the buyer. The interest rate reduction can be effective over a predetermined period of time, usually less than or equal to five years. The buyer can present the financial instrument to a lender when applying for a mortgage. This financial instrument can be used with, or attached to, any type of mortgage obtained by the buyer. The lender can redeem the financial instrument for the amount of seller paid points. The lender can then reduce the buyer's loan payments over the predetermined period of time, based on the amount of seller paid points. The buyer can benefit from the lowered loan payments over the predetermined period of time and can also benefit by increased tax deductions. The buyer can typically deduct the amount of seller paid points, which prepay interest, from a gross income amount, thereby decreasing an amount of taxes owed.

### BRIEF DESCRIPTION OF THE DRAWINGS

The features, objects, and advantages of embodiments of the disclosure will become more apparent from the detailed description set forth below when taken in conjunction with the drawings, in which like elements bear like reference numerals.

FIG. 1 is a functional block diagram of a real estate finance system of the present disclosure implemented in a network of computers.

FIG. 2 is a functional block diagram of a computer that can be used in the network of FIG. 1.

FIG. 3 is a functional block diagram of a real estate finance system of the present disclosure.

FIG. 4 is a flowchart of a real estate transaction using the financial instrument of the present disclosure.

FIG. 5 is a flowchart of a process for generating a financial instrument of the disclosure.

FIG. 6 is a flowchart of a process for generating a loan of the disclosure.

FIG. 7 is a flowchart of a process of a builder using the financial instrument as a buyer incentive.

FIG. 8 is a graph comparing cumulative net present value of a buydown to that of a comparable loan using the financial instrument.

### DETAILED DESCRIPTION OF THE DISCLOSURE

Numerous factors contribute to total buyer costs in a real estate transaction such as a residential real estate purchase, also referred to as a home purchase. A buyer typically weighs the desirability of a home against its offered price, available cash for a down payment, prevailing mortgage interest rates, loan costs, and other costs associated with purchasing a home. Often, the buyer will have one budget for down payment plus closing costs and another budget for monthly mortgage payments relative to expected earnings.

Additionally, numerous parties are typically involved in a home purchase transaction. The parties typically include a seller, which may be an individual but can also be a developer, a buyer, a real estate agent, a lender, a mortgage broker, and an escrow office. Each of these parties can participate in a single transaction.

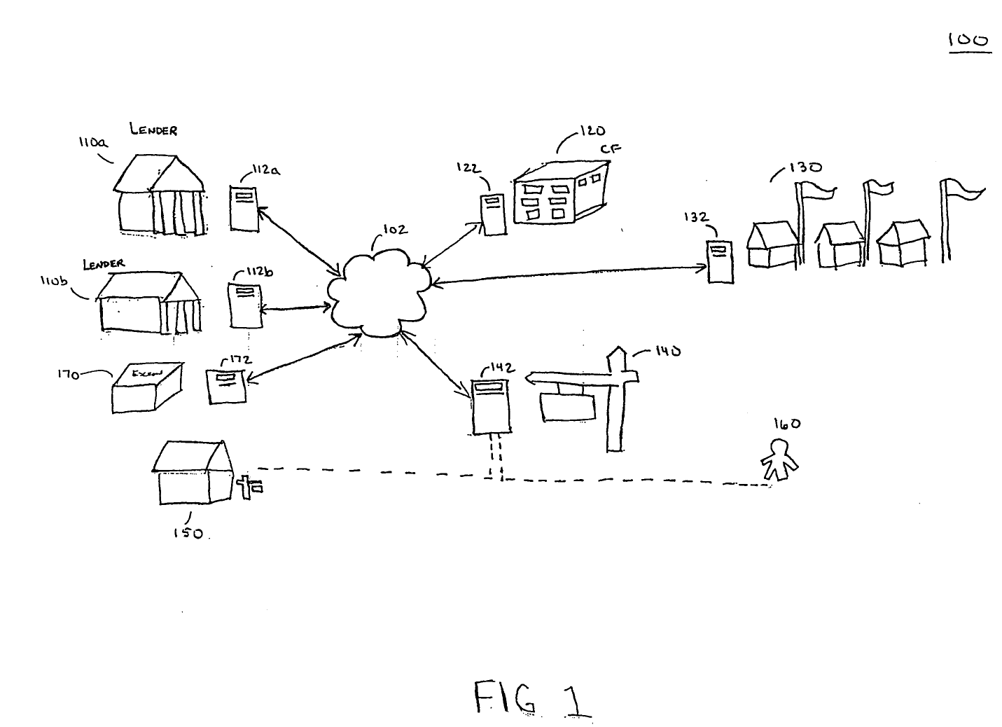

FIG. 1 is a functional block diagram showing a real estate finance system 100. A buyer and seller can structure a transaction through a system 100 participant. The system participant can help to structure the real estate transaction using a financial instrument that facilitates the transaction while maximizing value for all parties.

In a typical home sale, a seller markets the home through a real estate agent to potential buyers. The seller markets the home at a particular listing price. One or more potential buyers can view the property and submit to the seller an offer to purchase the home.

For example, assume that one or more buyers submit offers to the seller. Each of the offers can be below the seller's asking price. The best offer may be below a minimum that the seller is willing to accept for the home and may also be as much as a buyer can afford when using conventional real estate lending techniques.

However, the seller and buyer may meet at some common selling price that is above the seller's minimum and above the conventional buyer maximum by using the financial instrument as detailed in the disclosure. The seller can determine an acceptable amount below the asking price. The seller can then use that amount to purchase a financial instrument that can be used to prepay the interest on a buyer's loan for a predetermined period of time. The seller need not fund the financial instrument at the time the instrument is generated, but instead, may obligate an amount that may be paid from sale proceeds.

The seller can offer the financial instrument to the buyer as an incentive to pay the full, or close to full, asking price for the home. The buyer would need a down payment and loan sufficient to finance the transaction. However, the effective interest rate on the buyer's loan can be significantly reduced over the predetermined period of time detailed in the financial instrument. Thus, the buyer can realize a loan payment for the higher selling price that is lower than an equivalent loan payment for the initial offering price. The lower payment is achieved through the seller's prepaid interest and exists for a specified term. Typically, the term can be structured to be a length of time sufficient for the buyer to have an increased cash flow, or for interest rates to decline such that refinancing is desirable.

Because the seller can prepay interest on the buyer's loan, the cost can qualify as seller paid points. Under the current U.S. income tax structure, seller paid points for prepaid interest can be deducted by the buyer in the year paid. Additionally, because the loan's effective interest rate is lower during the period, the buyer does not spend as much to service the loan during the years immediately following the purchase. Often the years immediately following the purchase of the home represent the years in which a buyer's cash flow is most limited.

A buydown is a financing tool that has also been used by a buyer to qualify for a home loan. The lender structures a mortgage that has different interest rates for different periods of time. One example is a 3-2-1 buydown where the interest rate is reduced by 3 percentage points in year one, two in year two and one in year three. Payments are calculated as if the current year's rate were to be used for the balance of the mortgage. The result of this calculation is that principal is repaid more quickly than in a mortgage at the prevailing rate without the buydown.

The theoretical calculation of the cost of the buydown is an annuity calculation whereby the reduced future payments are discounted back to the present using a discount factor equal to the lender's cost of capital. In practice, the lender charges a premium for this type of loan because he is usually dealing with a sub-prime borrower who is stretching to make a purchase.

A complicating factor to the strict theoretical calculation of an annuity value is that homes are usually sold or refinanced before the term of the mortgage. The lender can factor that uncertainty into his pricing of the buydown by excluding future discounts after some future date of his choosing.

In practice, very few buydowns are being done nowadays. There are other ways to get someone into a home and standards are very relaxed as far as down payments required and the verification of actual income. Also, it is difficult to include such a non-standard loan in any pool of mortgages that a lender periodically sells to raise capital.

The system 100 used to implement the benefits of the real estate financial instrument can include a plurality of networked computers. A computer can be located at each of the commercial offices of the parties that are typically involved in a real estate transaction.

Multiple lenders 110a-110b have corresponding computers 112a-112b that are coupled to a network 102. The computers 112a-112b can communicate with each other and can typically communicate with many types of devices that are also coupled to the network 102.

A financial instrument generator 120 can also include a computer 122 that is coupled to the network 102 and in communication with other devices coupled to the network 102. The financial instrument generator 120 can, for example, accept input data from and/or negotiate with lenders 110a and 110b a schedule of costs associated with interest rate reductions provided by the lender. The financial instrument generator 120 can then offer a financial instrument to a seller that can be accepted by one of the lenders 110a and 110b to provide a buyer with a predetermined interest reduction over a predetermined term.

A developer 130 can also include a computer 132 that is coupled to the network 102. The developer 130 can work with the financial instrument generator 120 to generate financial instruments that offer buyers different values that may depend on current market conditions or on a particular development phase in which the home is purchased. For example, the developer 130 may use the financial instrument to provide buyers with a discount if the buyers purchase homes during an early development phase. The developer 130 may provide successively lower financial instrument benefits for buyers purchasing homes in later phases of development. The developer may encourage sales in early phases while supporting the price of later phases of the development.

A real estate agent 140 working with a seller 150 and a buyer 160 may also have a computer 142 that is coupled to the network 102. The real estate agent 140 may encourage the seller or the buyer to structure a deal using the financial instrument to facilitate the real estate transaction. Additionally, the real estate agent 140 may receive an added benefit because the real estate agent's fee may be proportional to the selling price. The selling price is typically higher when the financial instrument is used.

An escrow office 170 is also typically included within a real estate transaction. The escrow office 170 can include a computer 172 that is coupled to the network 102. The escrow office 170 can, for example, hold the funds associated with the real estate transaction and distribute them to the appropriate parties. In one embodiment, the escrow office 170 may receive funds from a lender, e.g. 110a, and distribute the funds to a seller's lender to pay off any mortgage due. The escrow office 170 may also pay the holder of the financial instrument the value of the instrument from seller proceeds. The holder of the financial instrument may be, for example, the buyer's lender.

Although the system 100 shows only two lenders 110a and 110b, the system may include any number of lenders and the number of lenders that participate in the finance system 100 is not limited to two. Similarly, although only one financial instrument generator 120, developer 130, real estate agent 140, and escrow office 170 are shown, more than one of each party can be part of the finance system 100, and the number of each party need not be the same. Additionally, the parties shown in the system 100 are typical participants in a real estate transaction. However, one or more of the parties may be omitted without departing from the disclosure. For example, although a real estate agent 140 typically arranges a transaction between a buyer 160 and a seller 150, participation of a real estate agent 140 is not a system 100 requirement and the services of the agent 140 can be omitted or performed by other parties without departing from the scope of the disclosure.

The various parties are also shown as independent parties. However, one or more of the parties may be integrated, or one or more of the parties may be separated into a number of sub-parties. For example, the financial instrument generator 120 may be integrated with one or more of the lenders 110a-110b. Additionally, the developer 130 acts as a seller 150 when selling the various development properties.

Each participant in the system 100 is illustrated as an individual party with a single computer. However, each of the parties can include multiple affiliates and can include one or more computers that are each coupled to the network 102. For example a particular lender, for example 110a, can include numerous branches. Each of the branches may include one or more computers and the computers can be linked using networks or connections. One or more of the branch computers may be coupled to the network 102 that couple the other parties.

The network 102 can include a wired network, a wireless network, a Local Area Network (LAN), Metropolitan Area Network (MAN), Wide Area Network (WAN), and the like, or some other manner of linking communications. In one embodiment, the network 102 includes the Internet.

The various computers, for example 112a-112b can be the same types of communication device or can be distinct types of communication devices. For example, one or more communication devices in a sub-network may be configured to implement a majority of the functionality of the system 100. A computer may include servers or computers configured to operate as hosts.

The computers, for example 122, are not limited to any particular type of computer, but may be a communication device. For example, a communication device can be a server, a computer, a personal computer, a personal digital assistant, a terminal, a special purpose communication device, a telephone, a wireless telephone, and the like, or some other communication device.

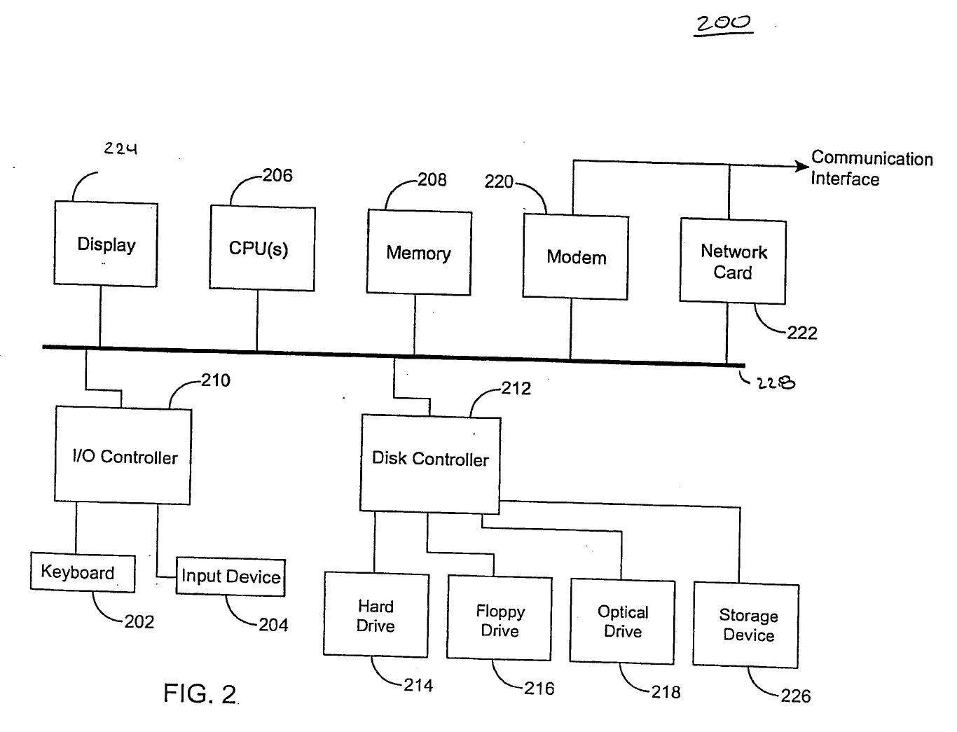

FIG. 2 is a functional block diagram of a computer 200 which may be illustrative of one or more of the computers, for example 112a, 122, or 142, shown in the system 100 of FIG. 1. The computer 200 can include a display 224, a keyboard 202, an input device 204, a processor 206, memory 208, an I/O controller 210, a disk controller 212, a hard drive 214, one or more removable storage drives, which can include a floppy drive 216 and an optical drive 218, a modem 220, a network interface card (NIC) 222, and one or more storage devices 226. The various elements can be coupled using one or more computer busses 228 within the computer 200. The one or more storage devices 226 can include, but are not limited to, ROM, RAM, non-volatile RAM, flash memory, magnetic storage, optical storage, tape storage, hard disk storage, and the like, or some other form of processor readable medium.

The memory 208 and the storage devices 226 can include one or more processor readable instructions stored as software. The software can be configured to direct the processor 206 to perform some or all of the functions within the finance system 100 of FIG. 1 or in subsequent figures. The software can include stand alone software executed by the processor 206, or the software can run within an operating system or within another software program.

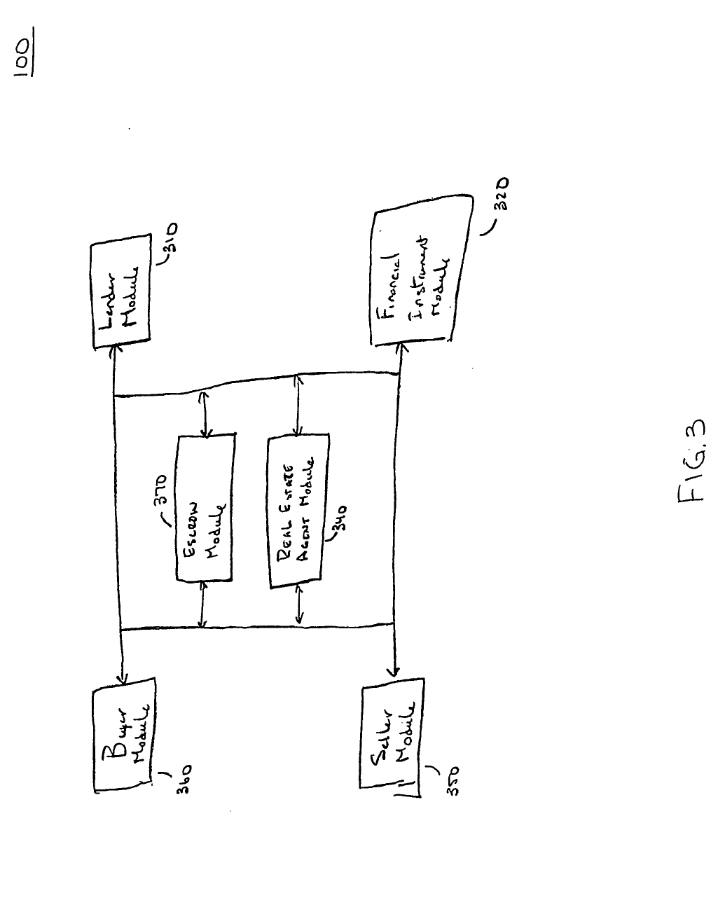

FIG. 3 is a functional block diagram of the real estate finance system 100. The functional block diagram can represent the same real estate finance system 100 shown in FIG. 1. The real estate finance system 100 includes a seller module 350 and a buyer module 360 that are each coupled to a lender module 310, financial instrument module 320, real estate agent module 340, and escrow module 370. The various modules can each be implemented, for example, as software of processor readable instructions stored in one or more storage devices in one or more of the computers shown in FIG. 1. Additionally, the various tasks performed by the modules may be divided or otherwise organized among the different modules and need not be organized as in the functional block diagram of FIG. 3.

Initially, a seller may desire to register with the real estate finance system 100 to increase the probability of achieving an acceptable selling price. The seller may provide registration information to the seller module 350. The seller module 350 may prompt for, and receive from the seller, for example, seller personal information, seller listing price, potential selling price, and a proposed amount to pay for a financial instrument. Once the seller has registered with the system 100, the seller module 350 may be configured to allow the seller to access and edit previously entered information. A major benefit to the seller of registration is that the seller can know precisely what his cost will be and what benefit he can offer.

The seller module 350 can, for example, provide a user interface that allows a seller to review multiple period and rate reduction alternatives. In one embodiment, the seller module 350 may provide the user with a prompt to select a period of time that defines the term of the rate reduction. The seller module 350 may display, for example, a pull down menu, slide bar, knob, or window offering a number of predetermined term options. In another embodiment, the seller module 350 may provide an input configured to receive a seller input term, such as a number of months. The seller module 350 may limit the length of the term that the seller can select, or the length of term may be unlimited. In one embodiment, the seller module 350 limits the maximum length of the rate reduction term to 36 months or less. In other embodiments, the term may be limited to 24 months, 48 months, 60 months, or some other length of time.

The seller module 350 may receive the seller input, determine a resultant effective rate reduction and mortgage reduction based in part on the previously received values for potential selling price and proposed amount to pay for the financial instrument. In one embodiment, the effective rate reduction typically results in a substantial decrease in interest that a buyer pays during the term of the financial instrument. Thus, the financial instrument results in a reduction of only the interest payments made by the buyer and does not affect the amount of principal paid by the buyer. The buyer may be able to deduct from gross wages the seller paid points in the year of the real estate transaction in order to obtain favorable income tax treatment. In other embodiments, the financial instrument may provide an effective interest rate reduction and may also provide a principal subsidy to the buyer. For example, the buyer may obtain an adjustable rate mortgage that has an extremely low initial interest rate. The effective interest rate reduction that is normally achieved by a financial instrument may exceed the interest rate paid by the buyer. Thus, the financial instrument may be structured to provide a principal subsidy during the term of the financial instrument as long as the buyer's interest rate is greater than the effective interest rate reduction value. In such a situation, the buyer may only be able take a tax deduction for a portion of the price paid by the seller for the financial instrument. In another example, the monthly subsidy could be adjusted to be smaller in some months and larger in others to optimize the tax treatment. The seller module 350 may then display the result to the seller.

Alternatively, the seller module 350 may determine a table of terms and rate reductions based on the data received from the seller. The seller module may determine the values based in part on information received from a lender module 310. For example, the seller module 350 may use a cost factor associated with generating the financial instrument and a lender discount factor to determine a rate of reduction for a given period of time. Alternatively, another module may generate the chart and communicate the chart, or otherwise make available the chart data to the seller module 350. The seller module 350 may then display the table or chart to the seller showing possible periods and rate reductions.

The seller module 350 may then accept a seller selection of a particular financial instrument that can include a cost, in terms of seller paid points, a term of rate reduction, and an amount of rate reduction. The seller module 350 may then store the seller selection and may communicate the seller selection to one or more of the other modules. Although the seller module 350 may interface directly with a seller, the module 350 may also receive inputs from a seller associate, such as a seller agent, lender, or buyer agent.

A lender module 310 may be accessed by a lender to input data associated with the financial instrument and to retrieve information provided by sellers, or the seller module 350. For example, each of a plurality of lenders may access the lender module 310 and input a lender discount factor, mortgage rate, and lender cost of funds. The lender module 310 may receive the data from each of the lenders and store the data in one or more storage devices. The lender module 310 may also receive data such as a prime rate or other financial index from one or more lenders or one or more other financial sources.

Lender data, such as lender discount factor and mortgage rates may change on a daily basis, and the lender module 310 may periodically receive these data from the lenders. The lender module 310 may communicate the data values to the seller module 350 to enable the seller module 350 to determine the various period and rate reduction alternatives available to a seller. Alternatively, the data may be stored in one or more storage devices that are accessible by the seller module 350.

A buyer module 360 may be similarly configured to receive buyer information. The buyer module 360 may be configured to receive buyer registration information, such as personal information. The buyer module 360 may also receive buyer input regarding particular properties for which the seller has already provided information. For example, the buyer module 360 may display periods and rate reductions being offered by sellers of particular properties of interest to the buyer.

Additionally, the buyer module 360 can be configured to provide to the buyer information about participating lenders and their respective mortgage rates. The buyer module 360 may also be configured to allow a buyer to suggest an alternative financial instrument period or rate reduction to a particular seller.

A financial instrument module 320 can be configured to determine the various rate reductions corresponding to periods of time. For example, the financial instrument module 320 may be configured to access the data provided by each participating lender, each of the sellers, and determine the rate reduction for a desired period of time. Additionally, the financial instrument module 320 can determine a rate sheet that displays the rate reduction corresponding to a predetermined mortgage amount and period of time for the rate reduction. For example, the financial instrument module 320 may determine a rate reduction in $reduction/$10,000 in mortgage amount.

The financial instrument module 320 may also be configured to generate and track the financial instruments. For example, the module 320 may generate a financial instrument that a seller purchases. Additionally, the financial instrument module 320 may track the financial instrument to determine when the instrument is redeemed and by what institution.

The financial instrument module 320 may also include software that performs optimization routines. For example, software in the module may determine a rate of return for lenders that maximizes system revenue, a net present value calculation for cost and monthly interest rate reduction, a table of rate reduction relative to period to maximize benefit to a buyer, parameters to allow a seller to maximize cash out, parameters to enable a buyer to choose appropriate terms to maximize home value.

The lender may be most interested in maximizing total profit from the transaction itself, not just from the sale of the financial instrument. A lender's larger gain typically comes from the mortgage itself. The lender will be likely to participate in the financing system to avoid losing the ability to do any of the loans involved with the program. Considering that not all lenders in a region will become participating lenders, access to do more loans means more total profit.

The lender can use the financial instrument module to interactively determine a price for the negotiable financial instrument. The lower the price and the higher the benefit to the buyer, the more financial instruments will be utilized and the more loans will be funneled into a relatively limited pool of lenders.

An example is that the lender, through the financial instrument module, chooses the appropriate discount factor to maximize the number of loans he can do. For the basic example of a $400,000 loan and a 3-point cost the price of the financial instrument is $12,000. The lender may subtract overhead costs and fees and then determine the value he can convey to the buyer. A simplifying assumption of $500 in fees and costs yields $11,500 that the lender receives to be allocated to the buyer's account. If this benefit accrues over a 36-month term, the lender can determine an acceptable discount rate. For example, the lender could choose to use a factor of 4% if that were his cost of funds, 6% if that were his prevailing mortgage rate, or 12% if that were his leveraged return on capital. The lender may choose a rate based on his risk aversion and assessment of future developments. The corresponding benefit would be $354/mo at a rate of 4%, $365 at a rate of 6%, and $399 at a rate of 12%. The financial instrument module 320 may allow the lender to use the net present value (NPV) calculation interactively to arrive at an answer, where:

$$NPV = {\sum }_{i = 1}^{n} \frac{values}{{( 1 + rate )}^{i}}$$

The calculation could also be performed in reverse to price the financial instrument given a desired monthly benefit. The desired monthly benefit can be calculated by starting with a desired effective interest rate reduction, for example, 1.5% for 3 years, and using standard mortgage payment formulas to determine the $/mo objective.

The parties, that is the lender, seller, and buyer, can determine a prospective benefit of the financial instrument that the buyer may receive without having any knowledge of the type of loan obtained by a buyer. A buyer can obtain a loan in the same manner as in the case of no financial instrument. The lender can establish an interest rate, principal amount, and can amortize the loan over the term of the mortgage. For example, the lender may amortize a $400,000 loan at 6% over a 30 year term to obtain a monthly payment value. The lender may then accept a financial instrument that provides the buyer an effective interest rate reduction. For example, the effective interest rate reduction may be 1.5% over a term of 3 years. In one embodiment, the lender does not re-amortize the loan, but instead, receives the value of the financial instrument in exchange for subsidizing a portion of the buyer's interest payments over the term of the financial instrument. Thus, the reduction may be an effective interest rate reduction because the mortgage remains a $400,000 mortgage at 6% over 30 years, but the buyer's mortgage payments are effectively reduced by an amount equivalent to 1.5% for the term of the financial instrument. The mortgage holder may receive payments as if the loan were a $400,000 mortgage at 6% over 30 years. The payments can come from a servicing company which collects from the buyer and supplements buyer payments with funds from the redeemed value of the financial instrument. The term “lender” may alternatively be referred to using the terms “mortgage holder” and “servicing company.”

The lender can assess the relative business that can be attained for the financial instrument at different levels of benefit. The lender can input relative profitability of instrument and loan and determine how aggressive he might be in pricing an instrument to gain access to the loan.

Once one or more of the lenders agree to a discount factor, tables may be constructed to allow variations in benefit and term and the benefits may be equated with an effective interest rate reduction. Buyers can peruse and interactively determine the benefit they need to fit their individual risk profile into the future.

The financial instrument system and method described herein is superior to a traditional buydown in several respects. It clearly conveys a specific benefit to each party to a real estate transaction for a particular period and a certain cost. A buydown is a financing tool for the buyer. Each lender prices it differently. The seller is not involved.

This instrument can be a marketing tool for the seller. It gives cost and benefit certainty to all parties to a real estate transaction. The seller of property knows what it will cost him to subsidize the buyer. The buyer knows the benefit he will receive over time. The lender knows how much he will receive up front and the maximum in payments that he will forego.

The seller of real property is not involved in buydowns, which are financing tools for the buyer to use to assist in qualifying for a loan. Buydowns are lender specific and the seller does not know who the buyer's lender will be. A developer might offer a buydown, but only if the buyer uses his lender.

The buyer may prefer this system to a buydown because the benefit he receives occurs entirely in the short term when it matters most to him. The lender will also have a certainty that is missing from a traditional buydown. Buydowns reduce monthly payments (as compared to a similar mortgage with the same interest rate and term) for the entire term of the mortgage. The focus may be on the short term, but the method also lowers all payments because principal is reduced more rapidly in the short term. Therefore, the lender is uncertain as to the maximum “liability” he faces because it ends only when the buyer sells or refinances. This financial instrument reduces payments only for a specific term. Therefore, the lender using it can clearly assess his risk because he knows his maximum liability.

The uncertainty in liability typically adds an element of risk in the lender's pricing of the buydown. The lender may add a risk premium to his net present value calculation to compensate for the uncertainty, increasing the cost of the financial tool.

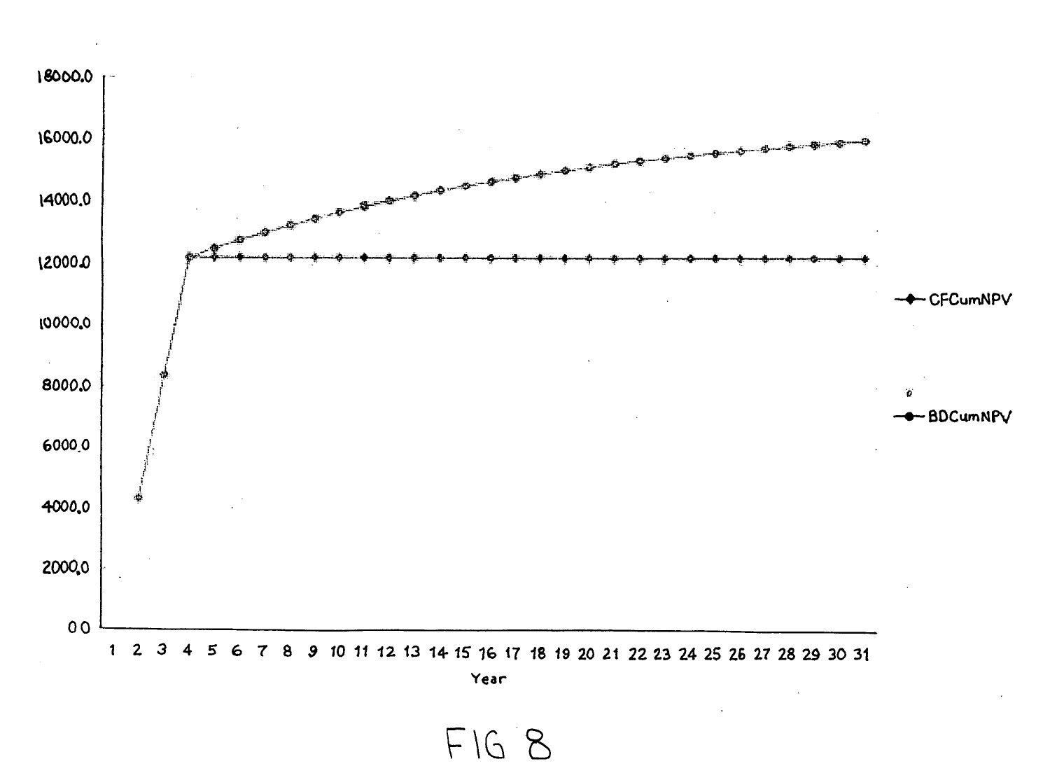

One example is graphically portrayed in FIG. 8 that compares a buydown of a 30 year, 6% loan, with interest reduced by 1.5% during the first 3 years to a comparable 30 year 6% loan with an effective reduction in interest rate of 1.5% over the first three years using the financial instrument. The gross benefit (decreased monthly payments, excluding tax considerations) to the buyer (liability to the lender) is the same for both tools for the first three years, but the buydown continues to decrease buyer payments and lender receipts beyond that period. The pricing of buydowns is now so variable among lenders because each lender must apply his own judgment as to when the property might next be sold or refinanced. The graph shows that the cost premium for the buydown would be approximately 10% above that of the loan with the financial instrument for an 8-year time horizon, 15% for 111 years, 20% for 15 years and 31% for 30 years. Because lenders typically prefer to avoid uncertainty, they will typically prefer the loan using the financial instrument.

A more common approach by a buyer is to pay points to reduce the interest rate for the full term of the mortgage. Again, the cost varies from lender to lender, but the rule of thumb is that the interest rate is reduced by 14% for each point paid. A present value analysis of that fact, using the mortgage rate as the discount factor concludes that lenders feel comfortable assuming a sale or refinance on average in the 7th year. A lender will charge a premium for a buydown because it is infrequently used and very difficult to package and sell. This analysis also indicates that the 15-20% premium is a minimum advantage likely to be seen by the financial instrument.

An escrow module 370 may track the transaction for each piece of property for which a financial instrument exists. The escrow module 370 may, for example, monitor the mortgage amount, down payment amount, and closing costs associated with a particular real estate transaction. The escrow module 370 may determine, for example, an amount that is to be deducted from seller proceeds to pay for the financial instrument.

A real estate agent module 340 may be used in addition to, or in place of, the seller module 350 and the buyer module 360. The real estate agent module 340 may be used, for example, to register a seller and piece of property with the system 100 when the seller initially lists the property with the agent. Other participating agents may then be able to view properties that are registered in the system 100.

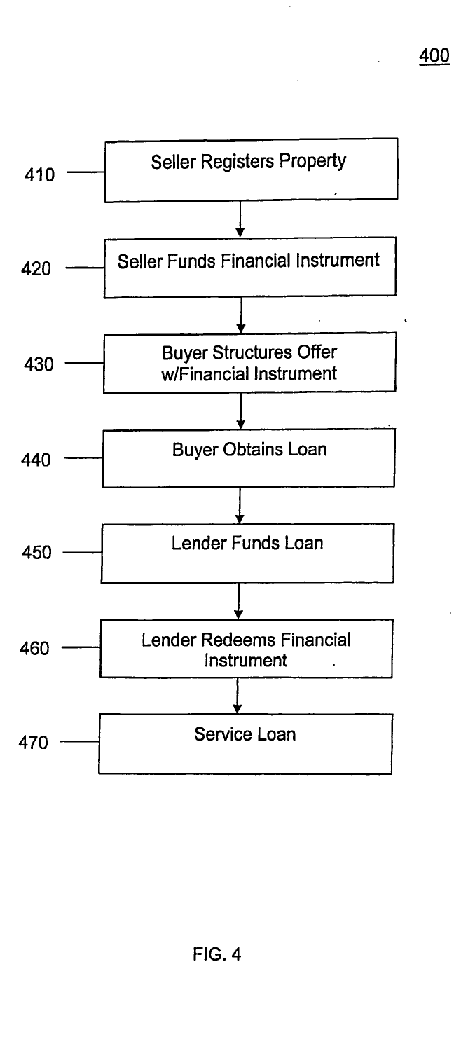

FIG. 4 is a flowchart of a process 400 for financing a residential real estate transaction that can be performed by the parties using the system of FIG. 1. The process 400 begins at block 410 where the seller registers with the real estate finance system. The seller may, for example, provide to the system personal information as well as information relating to the property. The system can receive the data and may also receive the magnitude of the seller paid points, which can be the value of the financial instrument.

At block 420, the seller funds or commits to fund the financial instrument that may be defined in registration block 410. For example, the seller may fund the financial instrument by paying the value of the instrument. Alternatively, the seller may fund the financial instrument by allocating a portion of funds that are due the seller upon close of escrow. In other embodiments, the seller may fund the financial instrument using a combination of allocation and payment. The seller may fund the financial instrument, for example, by inputting a funding option into a seller module from a selection of displayed funding options.

After the seller funds the financial instrument, the system may proceed to block 430. In block 430, the buyer structures an offer to submit to the seller. The buyer may construct the offer with knowledge of the financial instrument, and may structure the offer based in part on the value of the financial instrument. In one embodiment, the system may receive the buyer information concerning the offer. The buyer and seller may iteratively negotiate and readjust the value of the financial instrument and the selling price until an agreed upon selling price is achieved.

Once the buyer and seller agree upon a selling price, the system may proceed to block 440. In block 440, the buyer applies for, and obtains a loan or mortgage from a lender. The buyer advantageously applies for and obtains a loan from a lender participating in the real estate finance system in order to receive the benefits of the financial instrument. A participating lender may provide a loan to a buyer with knowledge that the financial instrument may be redeemed for its value upon close of escrow. The lender may input the loan information into the real estate finance system, or may otherwise inform an escrow office of the existence of the loan.

After the buyer obtains the loan, the system can proceed to block 450 where the lender funds the loan. The lender typically funds the loan by transferring the value of the mortgage to the escrow office. The real estate finance system may be updated to indicate the loan is funded.

The real estate transaction is typically near completion once the lender funds the loan. After the loan is funded, the system proceeds to block 460. In block 460, the lender redeems the financial instrument, typically by receiving a portion of the escrow proceeds. Thus, in effect, a portion of the interest on the loan is immediately prepaid by the seller. Lenders are typically favorably disposed to upfront fees and points for reasons of both earnings and cash flow, and this instrument may be particularly desirable because the lender keeps the fee even if the buyer sells or refinances the house within the term of the financial instrument. The lender may update the system to indicate redemption of the financial instrument.

After escrow for the real estate transaction is closed, the loan is serviced in block 470 of the process 400. The lender has prepaid interest in the value of the financial instrument. The lender also holds a mortgage for at least a portion of the value of the property. The lender releases the buyer from a portion of the mortgage payment for the period of time indicated in the financial instrument. Thus, if the financial instrument has a period of three years, the lender accepts a reduced mortgage payment from the buyer for those three years. The remainder of the mortgage payment is prepaid by the seller.

As an example, suppose a home seller offers a home at a listing price of $400,000. A buyer may not be willing to submit an offer for that amount, or a buyer may not be comfortable with the initial payments that will be required to service a loan for a $400,000 home. Suppose the buyer offers $350,000 for the home. This amount may be insufficient for the seller and the seller would in a typical situation reject such an offer. The seller could reduce the price and effectively subsidize the buyer over all 30 years of a typical mortgage. The seller may choose to subsidize the buyer only during the early years where budget and cash flow for the buyer are typically of greater concern.

The seller may instead, offer to sell the home to the buyer for $400,000 but offer to purchase a $12,000 financial instrument for the buyer. The sale price of the home would remain $400,000, but the seller would offer $12,000 of the selling price in the form of seller paid points. In this example, $12,000 represents three points, or three percent of the selling price.

The financial instrument may be used to provide an interest rate reduction for the buyer's mortgage over a predetermined length of time. For example, the amount of seller paid points may provide the buyer with an effective 1.5% interest rate reduction over a term of three years.

The buyer could then reduce mortgage payments over the length of the period defined in the financial instrument. If a buyer can make a down payment of 20%, the mortgage amount can be (0.80×$400,000)=$320,000. A $320,000 loan over 30 years at an interest rate of 7% requires a monthly payment of substantially $2129.

The seller prepaid points may, in effect, buy down the interest rate 1.5% over a term of three years. Thus, for the first three years of the mortgage, the buyer's payments would only be substantially $1817, corresponding to a $320,000 loan over 30 years at a 5.5% interest rate. This payment corresponds to less than the equivalent payment for a $280,000 loan over 30 years at the prevailing 7% interest rate. Thus, although the buyer obtains a $320,000 loan, the payment over the first three years is less than the payment for a $280,000 loan, which represents 80% of the buyer's original offer of $350,000.

The buyer receives a benefit of approximately $312 per month for the first three years of the loan. Additionally, under current U.S. income tax laws, the buyer may be able to deduct the $12,000 of seller prepaid points in the year of the real estate transaction. Thus, the buyer receives an additional benefit of increased tax deductions. After the term of the financial instrument, the buyer's mortgage returns to the conventional payment amount of $2129 and remains there for the remainder of the mortgage.

In contrast, if the buyer instead were to pay the seller $388,000 corresponding to the seller's equivalent realized amount, a 20% down payment would only be $77,600 and the loan would be for $310,400. A loan for $310,400 over 30 years at an interest rate of 7% requires a loan payment of approximately $2065.

This amount is almost $250 more than the $1817 payment that the buyer pays if the financial instrument is in place. However, after the term of the financial instrument expires, the buyer purchasing for $400,000 with the financial instrument pays approximately $64 more than the buyer purchasing for $388,000 without the financial instrument.

Taking into account only the difference in payments, the two buyers would pay equal total monthly payments after 175 months, or almost 15 years. The typical homeowner sells a home or refinances a mortgage before occupying it for ten years.

The buyer receives a further benefit when selling the home because the basis price of the home is the purchase price. In the case of the buyer using the financial instrument, the basis for the home is $400,000. The higher basis can help reduce the amount of any capital gains that may result in buyer taxes. Thus, the buyer benefits greatly in the first year, during the term of the interest rate reduction, and at the subsequent sale of the home. The buyer does not realize any detriment unless the buyer maintains the same loan for well over ten years.

Because the buyer typically receives raises in income over time, and because of the time value of money, the amount of savings realized in the first few years after an initial home purchase are typically much more valuable than an equivalent savings ten years later. Thus, by taking advantage of the financial instrument, the buyer saves in the first critical years following the home purchase.

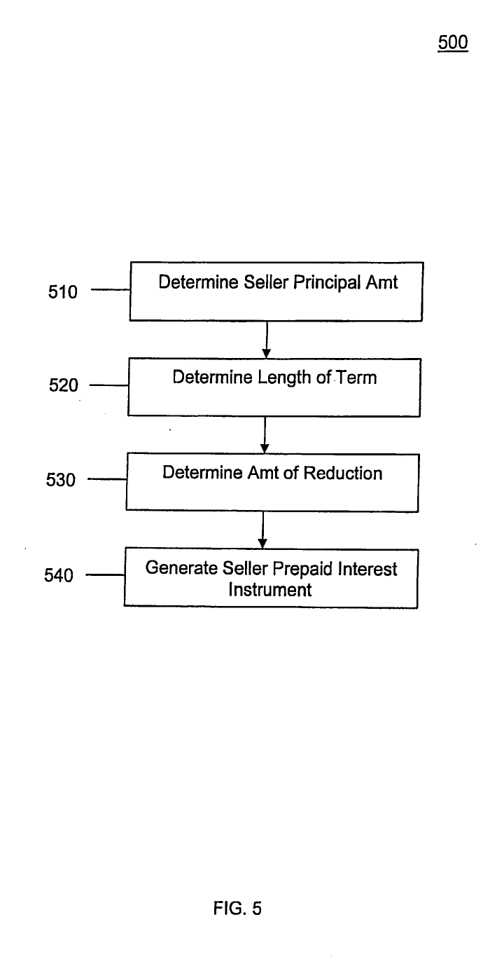

FIG. 5 is a flowchart of a process 500 for generating a financial instrument. The process 500 may be performed by the financial instrument generator 120 of FIG. 1 using, for example, the financial instrument module 320 in the system of FIG. 3.

The process 500 begins at block 510 when the financial instrument generator determines a seller principal amount. The seller principal amount may correspond to the amount the seller is willing to allocate to the financial instrument. For example, the seller may be willing to pay up to three points, or three percent of a buyer loan. If the buyer obtains a loan in the amount of $400,000, the seller may be willing to provide $12,000 in principal to fund the financial instrument.

Once the system determines the amount of principal, the system may proceed to block 520 to determine a length of term or period over which the principal is to be applied. The shorter the term, the greater will be each of the installments based on the principal. The system using, for example, the seller module, may prompt a seller for a desired term. The term is typically measured in terms of months and the number of months typically does not exceed thirty-six. In other embodiments, the term may not exceed forty-eight months or sixty months.

After determining the period of time that a rate reduction is applied, the system proceeds to block 530 to determine the amount of each reduction. The amount of reduction may be determined using any number of methods. For example, the principal value may be distributed as a number of equal payments, the number equal to the desired term. A differential interest rate can be derived by determining the contribution due to equal payments of the principal over the term.

The process 500 may repeat the actions performed in blocks 510, 520 and 530 until the seller or the combination of the seller and the buyer is satisfied with the results. Once the principal, term, and reduction are determined, the system proceeds to block 540 where the financial instrument is generated. The financial instrument may be an actual document, such as a contract having specific terms, or may be an electronic file, an electronic indicator such as a flag or byte or collection of bytes, or an instrument that records the specifics of the agreement.

Additionally, although the flowchart shows a sequence of steps in the process 500, the steps of the process 500 may be reordered. For example, block 530 where the amount of payment reduction is determined, may be determined based on seller or buyer input. Then block 510, where the seller principal payment is determined, may occur after block 530 and the seller principal may be determined based at least in part on the desired payment reduction.

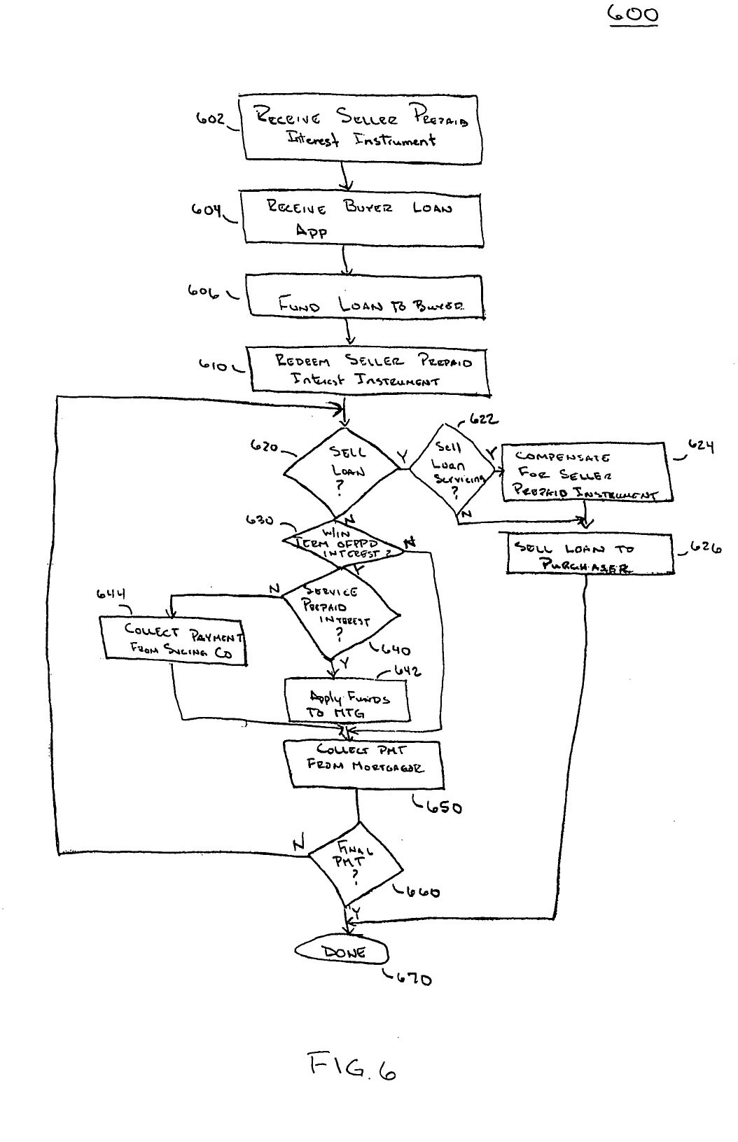

FIG. 6 is a flowchart of an embodiment of a process 600 for generating a loan within the real estate finance system, taking into account the value of seller prepaid interest represented in the financial instrument. The process 600 may be performed, for example, by the finance systems of FIGS. 1 and 3. In one embodiment, the process 600 may be performed by the lender module 310 of FIG. 3.

The process 600 may begin at block 602 where a financial institution, such as a bank or a lender, receives the financial instrument. The financial instrument details the amount of seller prepaid interest and the term over which the prepaid interest is to be applied. As described earlier, the term and amount of rate reduction that a lender may provide for a given seller principal value can be dependent on, for example, the lender's cost of funds, the lender's discount factor, and other factors. The lender may receive an actual document, or may electronically receive the financial instrument, or some electronic indicator of the financial instrument, via the lender module of FIG. 3.

After receiving the financial instrument, the finance system may proceed to block 604 and may receive the buyer loan application. The lender may process a buyer loan application in much the same way that a lender processes a conventional loan application. The lender can qualify and approve the buyer for the loan based on a number of factors.

The finance system proceeds to block 606 once the buyer is approved for a loan. At block 606, the lender may, via the finance system, fund the loan by transferring funds to an escrow agent or some other party.

The system may then proceed to block 610. At block 610, the lender may, via the finance system, redeem the financial instrument. In one embodiment, the lender receives a predetermined portion of seller proceeds held in escrow. In another embodiment, the seller prepays the financial instrument principal amount, either to an escrow agent or to a financial instrument generator, and the lender receives the principal amount from the party holding the funds. In still another embodiment, the lender may redeem the financial instrument by receiving payment from the seller.

After redeeming the financial instrument, the lender may have the value of the financial instrument in the form of a cash payment and may hold a mortgage on the buyer's property. The lender holds a mortgage for the amount financed by the buyer, but a portion of the interest may be prepaid by the value of the financial instrument. Thus, for the term defined in the financial instrument, the lender receives a smaller payment from the buyer. The buyer's payments are effectively subsidized by the seller for the term defined in the financial instrument. Once the term defined in the financial instrument has elapsed, the lender receives the full mortgage payment from the buyer.

The lender has many options at this point and may decide to retain the mortgage and service the mortgage along with the prepaid interest. Alternatively, the lender may sell the mortgage or sell the servicing of the mortgage. Similarly, the lender may service the prepaid interest portion of the loan or may sell the servicing of the prepaid interest term.

The system proceeds to decision block 620 where the lender decides whether to sell the loan. There are many tiers of mortgage lenders, large, medium and small. Some specialize in large loans and some in sub-prime loans that may have a higher credit risk.

Lenders typically take debt and equity capital and invest in mortgages. Their return on equity is the difference between mortgage interest rates and their cost of debt after subtracting other operating costs. Lenders sell loans from their mortgage portfolio to capitalize the interest rate spread and immediately realize some profits that can be reinvested. Buyers of these mortgages include Fannie Mae (FNMA) and Freddie Mac (FHLMC).

Many lenders have loan servicing operations that bill customers and credit mortgage payments to the proper accounts. The largest lenders may have established economies of scale that make the fees charged for this service to be very profitable. The attractiveness of this business can be such that the largest lenders prefer to retain the loan servicing even if they sell the underlying mortgage.

Another reason for lenders to retain the servicing business is because SEC reporting guidelines allow them to count future mortgage servicing income as income today. However, if the servicing leaves with the loan, the income already reported must be recaptured, lowering the current period's reported income.

Therefore, a loan with an associated financial instrument may be highly desirable to lenders because it makes it easier to sell the underlying loan while retaining the servicing. Because the financial instrument can be attached to any loan, that loan can be packaged and sold in a pool of other generic fixed or adjustable rate mortgages.

If the lender decides to sell the loan, the system proceeds to decision block 622 where the lender determines if loan servicing is to be sold with the loan. If the lender determines that the loan is to be sold with the servicing, the system proceeds to block 624. However, if the lender determines that the loan is to be sold without servicing, the system bypasses block 624 and proceeds to block 626.

If the lender decides to sell the mortgage with loan servicing, the system proceeds to block 624 and may compensate the selling price of the loan based in part on the cash received when the financial instrument was redeemed. The lender may also compensate the selling price of the loan based on other factors, such as a change in interest rate or a change in lender's cost of funds, or some other factor.

After compensating the selling price of the loan or without any compensation if the lender is selling the loan without the servicing, the lender can proceed through the system to block 626 where the loan may be sold to a purchasing lender. After the loan and the loan processing are sold to a purchaser, the lender no longer has any connection to the mortgage. The system proceeds to block 670 and the process is done.

Returning to decision block 620, if the lender decides at this time not to sell the loan, the system proceeds to decision block 630 to determine whether current payment in the loan is in the period of interest rate reduction defined in the financial instrument. If so, the lender may receive a reduced payment amount from the buyer. Thus, if the loan is in the period of interest rate reduction, the system proceeds to decision block 644.

As noted earlier, the lender may choose to structure the loan as a mortgage in the full buyer amount with no interest rate reduction and subsidize the buyer payments with a portion of the amount received when the financial instrument is redeemed. The lender may choose to track such subsidized payments or may allow a servicing company track the payments attributable to the seller prepaid interest.

In decision block 640, the system determines whether the lender services the prepaid interest rate reduction. If so, the system proceeds to block 642 and the lender applies a portion of the prepaid interest to the amount due from the buyer. The system then proceeds to block 650.

Returning to decision block 640, if the system determines that the lender does not service the prepaid interest portion of the loan, the system proceeds to block 644 and the lender looks to a third party to receive a payment. The lender may, for example, collect the payment from a third party servicing company. After collecting the payment, the system proceeds to block 650.

Returning again to decision block 630, if the system determines that the current payment due from the buyer is not within the period of the interest rate reduction, the system proceeds to block 650. After the period of interest rate reduction expires, the servicing of the loan proceeds like any other loan serviced by the lender.

In block 650, the lender collects a payment from the buyer. The system then proceeds to decision block 660 to determine whether the final loan payment has been received from the buyer.

If not, the system proceeds back to decision block 620 and repeats the portion of the process 600 relating to servicing of the loan. If, at decision block 660 the system determines that the buyer has paid the final payment, the system proceeds to block 670 and the process 600 is done.

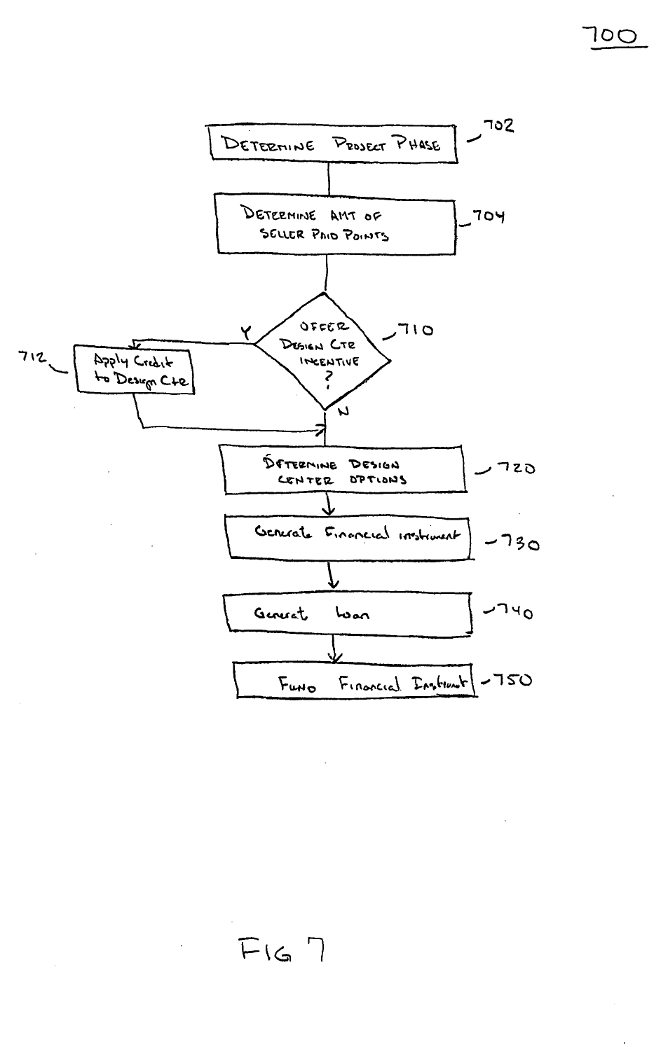

FIG. 7 is a flowchart of an embodiment of a process 700 for a builder to use the financial instrument as a buyer incentive. The process 700 may be used, for example, by a builder in the real estate finance system shown in FIG. 1 or 3.

The process 700 may begin when the developer determines that the financial instrument can be used as a buyer incentive for one or more phases of a multi-phase development. Typically, a developer lists homes in an initial phase at a discount and steadily increases the home prices in subsequent phases. The developer may use real estate finance system to provide a buyer incentive during the earlier phases while maintaining a steady listing price over multiple phases of the development.

The process 700 begins at block 702 where a developer, using the real estate finance system, determines an applicable phase of a plurality of development phases. For example, the developer may choose to use the real estate finance system for only a subset of development phases. After determining an applicable phase, the system can proceed to block 704 where the developer can determine an amount of prepaid points to offer. In another embodiment, the developer may determine an amount of payment reduction or an amount of principal to invest in a seller prepaid points financial instrument. Regardless of the method chosen by the developer, the developer determines some amount of seller points corresponding to an interest rate reduction or a payment reduction over a period of time.

The system then proceeds to decision block 710 where the developer can determine whether to offer a design center incentive that can be based, at least in part, on the amount of seller paid points. For example, a developer may offer an incentive for the buyer to use in the developer's design center when choosing design options.

The buyer benefits by choosing to participate in any seller paid point program because the buyer may select more options while maintaining the same payment that would be paid without the benefit of seller prepaid points. However, such savings would only occur for the period of the interest rate reduction.

The developer benefits because the listing price of homes in early phases may match the listing price of homes in subsequent home phases. Additionally, the rate at which buyers rescind their offers can be reduced by allowing the buyers to personalize their homes with buyer selected options. A buyer that has personalized a home by selecting options may be more committed to a home and more reluctant to rescind an offer because the property is personalized to their tastes.

If the developer offers a design center incentive, the system proceeds to block 712 where the developer applies some credit at the design center, for example, corresponding to the home phase and seller paid points. Alternatively, the developer may offer an effective design center credit where the developer offers to fund the financial instrument if the buyer upgrades the home to a more elaborate one and more expensive one with design features added. The system then proceeds to block 720.

Returning to decision block 710, if the developer does not offer a design center incentive, then the system proceeds to block 720. At block 720, the developer allows the buyer to select options in the design center.

The system proceeds to block 730 where the developer may generate the financial instrument that defines the amount of seller paid points, the corresponding amount of payment reduction, and the period of time that the reduction is in effect.

The system then proceeds to block 740 where lender, such as a bank or mortgage broker associated with the developer, generates a loan for the buyer. The loan may be generated in much the same manner as a typical home loan or as discussed in the flowchart of FIG. 6.

After the loan is generated, the system proceeds to block 750 where the developer funds the financial instrument. The developer may fund the financial instrument in much the same way an individual may fund the financial instrument. For example, the developer may allocate a portion of proceeds towards the financial instrument, or may pay the principal amount of the financial instrument.

A real estate finance system and method have been disclosed that allow for a buyer to realize a savings over the critical years immediately following a home purchase. A seller can pre-purchase or commit to purchase the financial instrument before a buyer has been identified and can offer the financial instrument to all potential buyers. The seller can achieve a higher selling price while at the same time the buyer can reduce mortgage payments over an initial period of the mortgage.

The various systems, methods, and devices disclosed are not intended to limit the scope of any systems, methods, and devices for building an abstraction, but rather are provided as examples to illustrate a general abstraction control solution. Those of ordinary skill in the art will recognize that modifications, design changes, and alternatives may be implemented without departing from the scope of the disclosure.

The various systems, methods, and devices disclosed are not intended to limit the scope of any systems, methods, and devices for real estate financing, but rather are provided as examples to illustrate a general real estate finance system. Those of ordinary skill in the art will recognize that modifications, design changes, and alternatives may be implemented without departing from the scope of the disclosure.

1. A method of financing a real estate transaction, the method comprising:
determining an amount of seller paid points;
determining a length of term;
determining an amount of reduction; and
generating a financial instrument redeemable for the amount of reduction over the length of term.

2. The method of claim 1, wherein determining the amount of seller paid points comprises determining an amount of prepaid points not to exceed three points.

3. The method of claim 1, wherein determining the length of term comprises determining a term of an effective interest rate reduction.

4. The method of claim 1, wherein the length of term is less than or equal to three years.

5. The method of claim 1, wherein the length of term is less than or equal to 2 years.

6. The method of claim 1, wherein the length of term is less than or equal to 4 years.

7. The method of claim 1, wherein the amount of reduction comprises an amount of effective mortgage interest rate reduction.

8. The method of claim 1, wherein the amount of reduction comprises an amount of interest payment reduction.

9. The method of claim 1, wherein determining the amount of reduction comprises determining an effective mortgage interest rate reduction based in part on the amount of seller paid points.

10. The method of claim 1, wherein determining the amount of reduction comprises determining an effective mortgage interest rate reduction based in part on the amount of seller paid points, the length of term, and a lender discount rate

11. A method of financing a real estate transaction, the method comprising:
receiving a financial instrument providing for an amount of seller prepaid points;
generating a mortgage;
redeeming the financial instrument for the amount of seller prepaid points; and
reducing buyer mortgage payments for a predetermined period of time, less than a term of the mortgage, based in part on the seller prepaid points.

12. The method of claim 11, wherein receiving the financial instrument comprises:
determining the amount of seller paid points;
determining a length of term;
determining an amount of reduction; and
generating the financial instrument redeemable for the amount of seller prepaid points.

13. The method of claim 11, wherein redeeming the financial instrument comprises receiving a value corresponding to the amount of seller paid points.

14. The method of claim 11, wherein redeeming the financial instrument comprises receiving a value corresponding to the amount of seller paid points from an escrow.

15. The method of claim 11, wherein the seller comprises a residential real estate seller.

16. The method of claim 11, further comprising receiving a buyer mortgage application.

17. The method of claim 11, wherein reducing buyer mortgage payments comprises reducing an effective interest rate of the mortgage for the predetermined period of time.

18. The method of claim 11, wherein the predetermined period of time is less than three years.

19. A method of financing a real estate transaction, the method comprising:
offering for sale a plurality of similarly priced homes in a plurality of phases;
paying seller paid points on at least one home of a first phase of the plurality of phases to reduce at least one first phase buyer's mortgage payment by a predetermined amount over a predetermined period of time less than a term of the mortgage; and
paying a reduced amount of seller paid points on at least one home of a subsequent phase of the plurality of phases to reduce at least one subsequent phase buyer's mortgage payment by an amount less than a reduction of the at least one first phase buyer's mortgage payment.

20. The method of claim 19, wherein paying seller paid points on at least one home of the first phase comprises paying seller paid points based in part on a buyer design center expenditure.

21. The method of claim 19, wherein paying seller paid points on at least one home of the subsequent phase comprises paying seller paid points based in part on a buyer design center expenditure.

22. The method of claim 19, further comprising offering a design center incentive based in part on the amount of seller paid points.

23. The method of claim 19, wherein an amount of seller paid points on the at least one home of a first phase does not exceed three points.

24. The method of claim 19, wherein the predetermined period of time does not exceed sixty months.

25. A real estate finance system, the system comprising:
a seller module configured to register a seller for a financial instrument having a defined benefit;
a financial instrument module in communication with the seller module and configured to generate a financial instrument redeemable for an amount of seller paid points; and
a lender module in communication with the financial instrument module configured to determine an effective interest rate reduction based in part on the amount of seller paid points.

26. The system of claim 25, wherein the seller module is further configured to accept a seller commitment to the amount of seller paid points.

27. The system of claim 25, wherein the lender module is further configured to determine a buyer mortgage and a mortgage payment having a reduced payment amount over a period defined by the financial instrument.

28. The system of claim 25, wherein the predetermined benefit comprises the effective interest rate reduction over a predetermined period of time.

29. The system of claim 25, wherein the lender module determines the effective interest rate reduction based in part on the amount of seller paid points and a lender cost of funds.

30. One or more processor readable storage devices having stored thereon one or more processor readable instructions, the processor readable instructions when executed by a processor performing the method comprising:
determining an amount of seller paid points;
determining a length of term;
determining an amount of reduction; and
generating a financial instrument redeemable for the amount of reduction over the length of term.
